(19) United States
(12) Patent Application Publication
(10) Pub. No.: US 2020/0102656 A1
(43) Pub. Date: Apr. 2, 2020

(54) STEEL PISTON HAVING A PHOSPHATE LAYER

(71) Applicants: FEDERAL-MOGUL NURNBERG GMBH, NURNBERG (DE); CHEMETALL GMBH, FRANKFURT AM MAIN (DE)

(72) Inventors: DOMINIK LEITZMANN, WEIHERHOF (DE); MONIKA BLUMM, FEUCHT (DE); MARGRIT DANNENFELDT, NURNBERG (DE); THOMAS FUHRMANN, LAUF/PEG (DE); MANFRED HAACK, NURNBERG (DE); JURGEN LUBER, TEUBLITZ (DE)

(21) Appl. No.: 16/611,030

(22) PCT Filed: May 4, 2018
(86) PCT No.: PCT/EP2018/061497

§ 371 Date: Nov. 5, 2019

(30) Foreign Application Priority Data
May 5, 2017 (DE) 10 2017 207 591.0

(51) Int. Cl. C23C 22/18; C23C 22/83; F02F 3/10

(52) U.S. Cl. CPC C23C 22/18; F02F 3/10; C23C 22/83

(57) ABSTRACT

A steel piston for an internal combustion engine includes an amorphous phosphate layer in at least one region thereof. On account of this layer the adhesion of an antifriction coating is improved.

### TECHNICAL FIELD

The present invention relates to a steel piston having an amorphous phosphate layer, in particular for an internal combustion engine, and to a method for the production thereof.

### PRIOR ART

Steel pistons for internal combustion engines are usually provided with a piston skirt coating for reducing friction against the cylinder and for preventing seizure. An antifriction coating containing one or more solid lubricants such as graphite or MoS₂, for example, is often used. When it is applied directly to the piston, the antifriction coating adheres primarily by way of mechanical adhesion.

In order to ensure the adhesion of the antifriction coating throughout the service life of the piston, the piston must be pre-treated. In the prior art, manganese phosphating is used for this, for example, which is applied using the dipping method. In order to be able to carry out this dipping process, it is necessary to interrupt the normal production process and to handle the piston manually. This may result in impurities on the surface of the piston.

As an alternative, it is possible to merely subject the steel piston to a neutral, alkaline and/or acidic wash prior to applying the antifriction coating. Since this process only removes grease from the surface, and does not abrade it, an unsatisfactory adhesion of the antifriction coating is frequently the result.

For these reasons, there is a need to provide a simple, low-cost method which results in an improved adhesion of the antifriction coating to the piston.

Surprisingly, this object is achieved by way of a specific method of phosphating and a steel piston having an amorphous phosphate layer obtainable by way thereof.

### DETAILED DESCRIPTION OF THE INVENTION

The invention relates to a steel piston, preferably a steel piston for an internal combustion engine, comprising an amorphous phosphate layer in at least one region thereof. Moreover, the invention relates to a method for producing such a steel piston.

According to the invention, the term “amorphous phosphate layer” means that the layer has an amorphous structure in plan view.

On account of this amorphous structure, the phosphate layer as according to the invention differs from conventional manganese phosphate layers or zinc phosphate layers with a crystalline structure. The amorphous structure of the layer has an impact on the properties of the layer, such as the roughness and thickness thereof.

The method according to the invention comprises the following steps:
(1) forming an amorphous phosphate layer by means of treatment with a solution containing phosphoric acid;
(2) optionally applying an antifriction coating; and
(3) optionally forming a manganese phosphate layer.

As a result of treatment with the solution containing phosphoric acid as in step (1), not only will an amorphous phosphate layer be formed, but the piston surface will also be abraded and any oxides present thereon will be removed.

The amorphous phosphate layer formed as according to the invention has capillaries and thereby facilitates a better anchoring of the antifriction coating, which can therefore also withstand high stress. Furthermore, the amorphous phosphate layer acts as a passivation layer, such that reoxidation of the piston is prevented.

Using the invention a thin, amorphous phosphate layer can be applied. In particular, this can be thinner than a conventional crystalline phosphate layer. This in turn facilitates lower manufacturing tolerances. Preferably, the amorphous phosphate layer will have a thickness of 0.05 μm to 5 μm, particularly preferably of 0.1 μm to 3 μm.

Within the scope of the invention the amorphous phosphate layer can be applied to the entire piston or to individual regions thereof, such as the piston skirt or the pin bore, for example. Preferably, the layer will be applied to the entire piston.

If desired, an antifriction coating (2) can also be applied to the amorphous phosphate layer. In step (3), a manganese phosphate layer is optionally applied to the piston thereby obtained.

The piston may of course also be coated only with the antifriction coating.

The solution containing phosphoric acid that is used according to the invention can be applied by means of spraying, so that the amorphous phosphate layer can be produced inline. This avoids the need to handle the piston manually and reduces the risk of impurities on the surface of the piston. Moreover, the method according to the invention can be integrated into the process for producing the piston without significant costs being incurred.

Preferably, the solution used in step (1) will contain a surfactant in addition to the phosphoric acid (orthophosphoric acid). As a result, the wetting of the surface is improved, such that a more even layer is formed. The solution may also contain additional components. Suitable additional components that have proved suitable include nitrates, such as sodium nitrate, manganese nitrate and zinc nitrate, and/or sulphonates.

In a preferred embodiment, the concentration of phosphoric acid in the solution is 4% to 14% (g/g), in particular 6% to 12% (g/g). The solution will preferably have a pH value of 1 to 3.

A temperature of 30° C. to 80° C., preferably 45° C. to 65° C., and a treatment duration of 50 seconds to 500 seconds, preferably 100 seconds to 400 seconds, have proved to be particularly suitable for carrying out step (1).

Once step (1) has been completed, the solution must be removed from the surface of the piston, for example by way of rinsing.

After step (1), an antifriction coating can be applied in an optional step (2). In this case, step (2) is performed using a method that is known to the person skilled in the art.

Subsequently, in a further step (3), a manganese phosphate layer may be formed on the piston obtained by way of the method according to the invention. This process can be carried out in a manner that is known to the person skilled in the art. As stated above, the treatment of the steel piston as according to the invention results in a better adhesion of the antifriction coating.

The antifriction coating will preferably be an antifriction coating comprising a polymer matrix. The usual starting materials for piston coatings, such as phenolic resins, epoxy resins, polyamide, polyamide-imide and/or PTFE, for example, may be used as the polymer matrix; preferably, phenolic resins and/or epoxy resins will be used.

If a crosslinkable polymer is used as the matrix for the coating, this will be cross-linked after application. The cross-linking of the matrix can take place thermally or by way of radiation, for example by means of UV radiation or infrared radiation.

The antifriction coating will particularly preferably also comprise functional components, such as one or more solid lubricants. According to the invention, substances with a laminar-like crystallising structure, such as graphite, MoS₂, WS₂ and α-BN, for example, will preferably be used as the solid lubricant(s). Polymers such as PTFE, for example, may also be used.

Suitable antifriction coatings whose adhesion can be improved by way of the amorphous phosphate layer as according to the invention are described in DE 10 2009 002 716 A1 and 10 2009 002 715 A1, for example.

1. A steel piston for an internal combustion engine, comprising an amorphous phosphate layer having a thickness of 0.05 μm to 3 μm in at least one region thereof, wherein the amorphous phosphate layer is obtainable by spraying a solution containing phosphoric acid onto the surface of the piston, and wherein an antifriction coating is applied to the amorphous phosphate layer.

2. The steel piston according to claim 1, wherein the amorphous phosphate layer has a thickness of 0.1 μm to 3 μm.

3. The steel piston according to claim 1, wherein further a manganese phosphate layer is applied to the amorphous phosphate layer.

4. The steel piston according to claim 1, wherein the layer(s) is/are applied at least to the piston skirt and/or the pin bore.

5. Method for producing a steel piston, comprising:
(1) forming an amorphous phosphate layer by spraying a solution containing phosphoric acid onto the surface of the piston;
(2) applying an antifriction coating; and
(3) optionally forming a manganese phosphate layer.

6. The method according to claim 5, wherein the solution used in step (1) also contains a surfactant.

7. The method according to claim 5, wherein the phosphoric acid concentration in the solution is 4% to 14% (g/g).

8. The method according to claim 5, wherein the solution used in step (1) has a pH value of 1 to 3.

9. The method according to claim 5, wherein the treatment in step (1) is carried out at a temperature of 30° C. to 80° C. for 50 seconds to 500 seconds.

10. Use of an amorphous phosphate layer having a thickness of 0.05 μm to 3 μm for improving the adhesion of an antifriction coating to a steel piston.

11. The steel piston of claim 4, wherein the layer is applied to the entire piston.

12. A steel piston having an amorphous phosphate layer and a coating of friction-reducing material applied to the amorphous phosphate layer.

13. The steel piston according to claim 12 wherein the amorphous phosphate layer has an amorphous structure in plan view.

14. The steel piston according to claim 12 wherein the amorphous phosphate coating is non-crystalline.
